(19) United States
(12) Patent Application Publication
(10) Pub. No.: US 2025/0155758 A1
(43) Pub. Date: May 15, 2025

(54) OPTICAL DEVICE

(71) Applicant: Japan Display Inc., Tokyo (JP)

(72) Inventors: Kojiro IKEDA, Tokyo (JP); Takeo KOITO, Tokyo (JP)

(21) Appl. No.: 19/021,816

(22) Filed: Jan. 15, 2025

Related U.S. Application Data
(63) Continuation of application No. PCT/JP2023/024894, filed on Jul. 5, 2023.

(30) Foreign Application Priority Data
Aug. 8, 2022 (JP) 2022-126305

(51) Int. Cl. G02F 1/1347; G02F 1/1343

(52) U.S. Cl. CPC G02F 1/1347; G02F 1/134309

(57) ABSTRACT

An optical device includes an optical element including a plurality of liquid crystal cells each including first and second substrates. In each of the plurality of liquid crystal cells, a first electrode and a second electrode on the first substrate respectively include a first straight line portion extending at an angle of α degrees (0<α<90) with respect to a first direction and a second straight line portion extending at an angle of β degrees (0<β<90 and β≠α) with respect to the first direction, and a third electrode and a fourth electrode on the second substrate respectively include a third straight line portion extending at an angle of (90+α) degrees with respect to the first direction and a fourth straight line portion extending at an angle of (90+β) degrees with respect to the first direction.

### CROSS-REFERENCE TO RELATED APPLICATIONS

This application is a Continuation of International Patent Application No. PCT/JP2023/024894, filed on Jul. 5, 2023, which claims the benefit of priority to Japanese Patent Application No. 2022-126305, filed on Aug. 8, 2022, the entire contents of which are incorporated herein by reference.

### FIELD

An embodiment of the present invention relates to an optical device that controls a distribution of light emitted from a light source.

### BACKGROUND

An optical element which is a so-called liquid crystal lens has been conventionally known in which a change in the refractive index of a liquid crystal is utilized by adjusting a voltage applied to the liquid crystal. Further, an optical device that uses the liquid crystal lens to control the distribution of light emitted from a light source has been developed (for example, see Japanese laid-open patent publication Nos. 2005-317879, 2010-230887, or 2014-160277).

### SUMMARY

An optical device includes a light source, and an optical element including a plurality of liquid crystal cells for controlling a distribution of light emitted from the light source. Each of the plurality of liquid crystal cells includes a first substrate on which a first electrode and a second electrode are alternately arranged, a second substrate on which a third electrode and a fourth electrode are alternately arranged, and a liquid crystal layer between the first substrate and the second substrate. Each of the first electrode and the second electrode includes a first straight line portion extending at an angle of α degrees (0<α<90) with respect to a first direction, and a second straight line portion extending at an angle of β degrees (0<β<90 and β≠α) with respect to the first direction. Each of the third electrode and the fourth electrode includes a third straight line portion extending at an angle of (90+α) degrees with respect to the first direction, and a fourth straight line portion extending at an angle of (90+β) degrees with respect to the first direction. The plurality of liquid crystal cells comprises a first liquid crystal cell arranged closest to the light source and a second liquid crystal cell arranged stacked on the first liquid crystal cell. The first substrate of the second liquid crystal cell faces the second substrate of the first liquid crystal cell. The second liquid crystal cell is arranged by overlapping the first liquid crystal cell so that an angle between the first direction of the first liquid crystal cell and the first direction of the second liquid crystal cell is 180 degrees.

### BRIEF DESCRIPTION OF DRAWINGS

FIG. 1 is a schematic perspective view of an optical device according to an embodiment of the present invention.

FIG. 2 is a schematic exploded perspective view of an optical element of an optical device according to an embodiment of the present invention.

FIG. 3 is a schematic perspective view of a first liquid crystal cell of an optical device according to an embodiment of the present invention.

FIG. 4A is a schematic cross-sectional view of a first liquid crystal cell of an optical device according to an embodiment of the present invention.

FIG. 4B is a schematic cross-sectional view of a first liquid crystal cell of an optical device according to an embodiment of the present invention.

FIG. 5A is a schematic cross-sectional view illustrating properties of light passing through a first liquid crystal cell of the optical device according to an embodiment of the present invention.

FIG. 5B is a schematic cross-sectional view illustrating properties of light passing through a first liquid crystal cell of the optical device according to an embodiment of the present invention.

FIG. 6A is a schematic plan view illustrating a planar pattern including transparent electrodes of a first liquid crystal cell of an optical device according to an embodiment of the present invention.

FIG. 6B is a schematic plan view illustrating a planar pattern including transparent electrodes of a first liquid crystal cell of an optical device according to an embodiment of the present invention.

FIG. 7 is a schematic plan view showing a planar pattern of transparent electrodes of a first liquid crystal cell of an optical device according to an embodiment of the present invention.

FIG. 8A is a schematic diagram illustrating angles of transparent electrodes in extending directions of a first liquid crystal cell of an optical device according to an embodiment of the present invention.

FIG. 8B is a schematic diagram illustrating angles of transparent electrodes in extending directions of a second liquid crystal cell of an optical device according to an embodiment of the present invention.

FIG. 8C is a schematic diagram illustrating angles of transparent electrodes in extending directions of a second liquid crystal cell of an optical device according to an embodiment of the present invention.

FIG. 8D is a schematic diagram illustrating angles of transparent electrodes in extending directions of a second liquid crystal cell of an optical device according to an embodiment of the present invention.

FIG. 9A is a schematic plan view showing an overlapping state of transparent electrodes extending in an x-axis direction in an optical device according to an embodiment of the present invention.

FIG. 9B is a schematic plan view showing an overlapping state of transparent electrodes extending in a y-axis direction in an optical device according to an embodiment of the present invention.

FIG. 10 is a schematic exploded perspective view of an optical element of an optical device according to an embodiment of the present invention.

FIG. 11A is a schematic diagram illustrating angles of transparent electrodes in extending directions of a third liquid crystal cell of an optical element included in an optical device according to an embodiment of the present invention.

FIG. 11B is a schematic diagram illustrating angles of transparent electrodes in extending directions of a fourth liquid crystal cell of an optical element included in an optical device according to an embodiment of the present invention.

FIG. 12 is a schematic plan view showing a planar pattern including a first transparent electrode and a second transparent electrode of a first liquid crystal cell of an optical device according to an embodiment of the present invention.

FIG. 13 is a schematic plan view showing a planar pattern including a first transparent electrode and a second transparent electrode of a first liquid crystal cell of an optical device according to an embodiment of the present invention.

FIG. 14 is a schematic plan view showing a planar pattern including a first transparent electrode and a second transparent electrode of a first liquid crystal cell of an optical device according to an embodiment of the present invention.

### DESCRIPTION OF EMBODIMENTS

When electrodes for applying a voltage to the liquid crystals in the stacked liquid crystal cells have the same shape and arrangement, interference fringes, moire, or coloring may occur in the diffused light. When it is possible to design the electrodes of the stacked liquid crystal cells so that their shape patterns are all different, this configuration increases the number of types of liquid crystal cells to be manufactured. Therefore, the manufacturing cost increases.

In view of the above problems, an embodiment of the present invention can provide an optical device with reduced manufacturing cost and reduced moire.

In the following description, each of the embodiments of the present invention is described with reference to the drawings. However, the present invention can be implemented in various modes without departing from the gist of the invention and should not be interpreted as being limited to the description of the embodiments exemplified below.

Although the drawings may be schematically represented in terms of width, thickness, shape, and the like of each part as compared with their actual mode in order to make explanation clearer, they are only an example and an interpretation of the present invention is not limited. In addition, in the drawings, the same reference numerals are provided to the same elements as those described previously with reference to preceding figures and repeated explanations may be omitted accordingly.

In the case when a single film is processed to form a plurality of structural bodies, each structural body may have different functions and roles, and the bases formed beneath each structural body may also be different. However, the plurality of structural bodies is derived from films formed in the same layer by the same process and have the same material. Therefore, the plurality of these films is defined as existing in the same layer.

When expressing a mode in which another structure is arranged over a certain structure, in the case where it is simply described as “over”, unless otherwise noted, a case where another structure is arranged directly over a certain structure as if in contact with that structure, and a case where another structure is arranged via yet another structure over a certain structure, are both included.

### First Embodiment

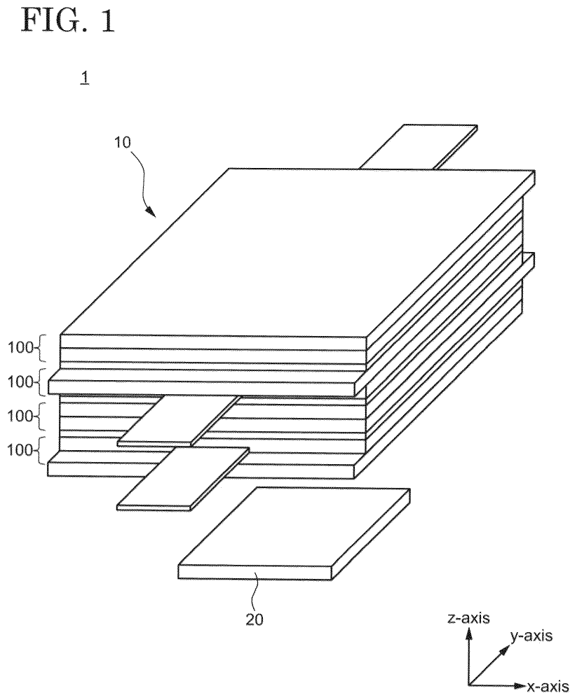

A lighting device 1 according to an embodiment of the present invention is described with reference to FIGS. 1 to 11B.

### [1. Configuration of Optical Device]

FIG. 1 is a schematic perspective view of an optical device 1 according to an embodiment of the present invention. As shown in FIG. 1, the optical device 1 includes an optical element 10 and a light source 20. Although a configuration of the optical element 10 is described in detail later, the optical element 10 includes a plurality of liquid crystal cells 100. The optical element 10 can change the shape of light passing through the optical element 10, i.e., a light distribution, by using the plurality of liquid crystal cells 100 to control the distribution of light emitted from the light source 20.

The light source 20 is not particularly limited to a certain configuration as long as it can emit light. For example, a light emitting diode (LED) or the like can be used as the light source 20.

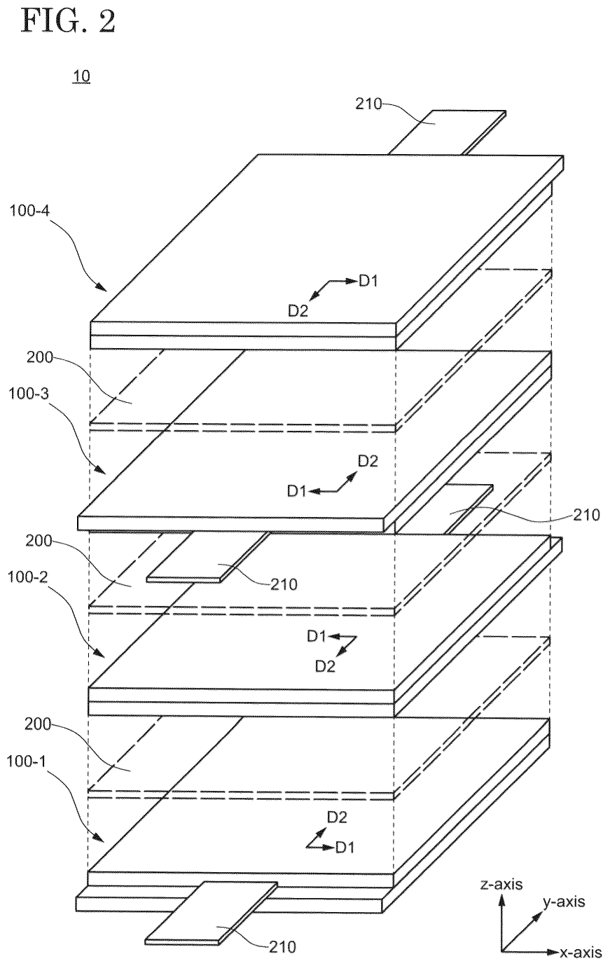

FIG. 2 is a schematic exploded perspective view of the optical element 10 of the optical device 1 according to an embodiment of the present invention. As shown in FIG. 2, the optical element 10 includes four liquid crystal cells 100 (a first liquid crystal cell 100-1, a second liquid crystal cell 100-2, a third liquid crystal cell 100-3, and a fourth liquid crystal cell 100-4). The first liquid crystal cell 100-1, the second liquid crystal cell 100-2, the third liquid crystal cell 100-3, and the fourth liquid crystal cell 100-4 are stacked and overlapped in this order from the light source 20 side in a z-axis direction. The first liquid crystal cell 100-1 is closest to the light source 20, and the fourth liquid crystal cell 100-4 is farthest from the light source 20. The number of liquid crystal cells 100 included in the optical element 10 is not limited to four. The optical element 10 only needs to include at least two liquid crystal cells 100.

Each of the four liquid crystal cells 100 includes connection terminals, which are described later. Flexible printed circuits (FPCs) 210 are connected to the connection terminals, and control signals are input to the liquid crystal cells 100 through the flexible printed circuits 210.

An optical elastic resin layer 200 is provided between two adjacent liquid crystal cells 100. That is, the optical elastic resin layers 200 are provided between the first liquid crystal cell 100-1 and the second liquid crystal cell 100-2, between the second liquid crystal cell 100-2 and the third liquid crystal cell 100-3, and between the third liquid crystal cell 100-3 and the fourth liquid crystal cell 100-4 in the optical element 10. The optical elastic resin layer 200 can bond and fix two adjacent liquid crystal cells 100. For example, an adhesive containing a light transmitting acrylic resin can be used for the optical elastic resin layer 200.

An x-axis, a y-axis, and a z-axis as shown in FIGS. 1 and 2 are defined with respect to the optical element 10 and are orthogonal to one another. The z-axis direction is the stacking direction of the plurality of liquid crystal cells 100, and the direction away from the light source 20 is a +direction. Each of the x-axis direction and the y-axis direction is a direction on a plane perpendicular to the z-axis.

The first liquid crystal cell 100-1, the second liquid crystal cell 100-2, the third liquid crystal cell 100-3, and the fourth liquid crystal cell 100-4 have the same configuration. That is, four liquid crystal cells 100 having the same configuration are stacked with their arrangement directions changed from each other in the optical element 10. As shown in FIG. 2, a first direction D1 and a second direction D2 of the first liquid crystal cell 100-1 correspond to the x-axis direction (+x direction) and the y-axis direction (+y direction) of the optical element 10, respectively. Hereinafter, for convenience, when describing the arrangement directions of the four liquid crystal cells 100 having the same configuration, the arrangement directions of the second liquid crystal cell 100-2, the third liquid crystal cell 100-3, and the fourth liquid crystal cell 100-4 are described based on the arrangement direction of the first liquid crystal cell 100-1 closest to the light source 20.

The first direction D1 and the second direction D2 of the second liquid crystal cell 100-2 are the −x direction and the −y direction, respectively. In other words, the second liquid crystal cell 100-2 is disposed on the first liquid crystal cell 100-1 such that the angle between the first direction D1 of the first liquid crystal cell 100-1 and the first direction D1 of the second liquid crystal cell 100-2 is 180 degrees, and the angle between the second direction D2 of the first liquid crystal cell 100-1 and the second direction D2 of the second liquid crystal cell 100-2 is 180 degrees.

The first direction D1 and the second direction D2 of the third liquid crystal cell 100-3 are the −x direction and the +y direction, respectively. In other words, the third liquid crystal cell 100-3 is disposed on the second liquid crystal cell 100-2 such that the angle between the first direction D1 of the first liquid crystal cell 100-1 and the first direction D1 of the third liquid crystal cell 100-3 is 180 degrees, and the angle between the second direction D2 of the first liquid crystal cell 100-1 and the second direction D2 of the third liquid crystal cell 100-3 is 0 degrees.

The first direction D1 and the second direction D2 of the fourth liquid crystal cell 100-4 are the +x direction and the −y direction, respectively. In other words, the fourth liquid crystal cell 100-4 is disposed on the third liquid crystal cell 100-3 such that the angle between the first direction D1 of the first liquid crystal cell 100-1 and the first direction D1 of the fourth liquid crystal cell 100-4 is 0 degrees, and the angle between the second direction D2 of the first liquid crystal cell 100-1 and the second direction D2 of the fourth liquid crystal cell 100-4 is 180 degrees.

In this way, the plurality of liquid crystal cells 100 having the same configuration are stacked in the optical element 10 so that the arrangement directions are different from each other, thereby reducing moire. Further, since the optical element 10 can be manufactured using one type of liquid crystal cell 100, the manufacturing cost of the optical device 1 can be reduced. Further, the optical element 10 may include liquid crystal cells having the same arrangement direction.

### [2. Configuration of Liquid Crystal Cell]

As described above, the first liquid crystal cell 100-1, the second liquid crystal cell 100-2, the third liquid crystal cell 100-3, and the fourth liquid crystal cell 100-4 are liquid crystal cells 100 having the same configuration. Therefore, the configuration of the liquid crystal cell 100 is described using the first liquid crystal cell 100-1 as an example in the following description.

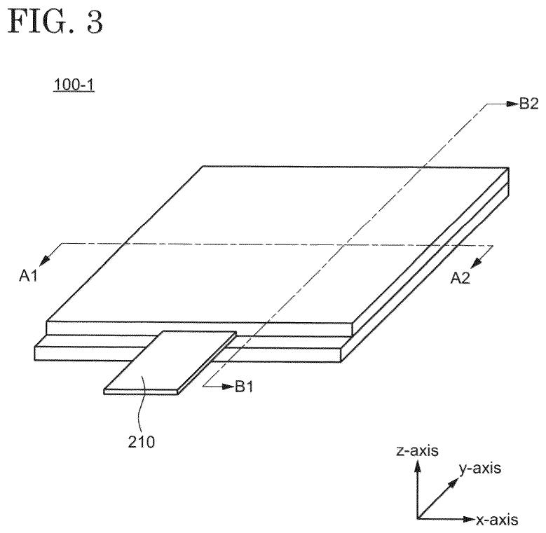

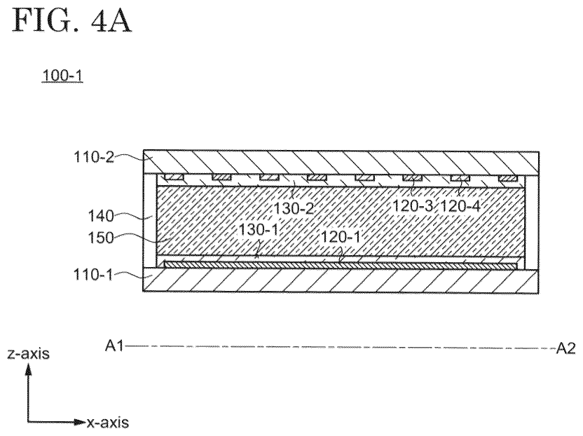

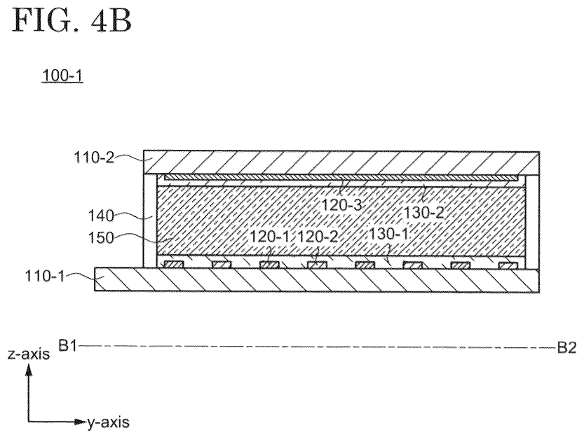

FIG. 3 is a schematic perspective view of the first liquid crystal cell 100-1 of the optical device 1 according to an embodiment of the present invention. FIGS. 4A and 4B are schematic cross-sectional views of the first liquid crystal cell 100-1 of the optical device 1 according to an embodiment of the present invention. Specifically, FIG. 4A is a cross-sectional view of the first liquid crystal cell 100-1 in a zx plane taken along line A1-A2 in FIG. 3, and FIG. 4B is a cross-sectional view of the first liquid crystal cell 100-1 in a yz plane taken along line B1-B2 in FIG. 3.

The first liquid crystal cell 100-1 includes a first substrate 110-1, a second substrate 110-2, a first transparent electrode 120-1, a second transparent electrode 120-2, a third transparent electrode 120-3, a fourth transparent electrode 120-4, a first alignment film 130-1, a second alignment film 130-2, a sealing member 140, and a liquid crystal layer 150. In the following description, when the first substrate 110-1 and the second substrate 110-2 are not particularly distinguished from each other, they may be referred to as a substrate 110. Similarly, when the first transparent electrode 120-1, the second transparent electrode 120-2, the third transparent electrode 120-3, and the fourth transparent electrode 120-4 are not particularly distinguished from each other, they may be referred to as a transparent electrode 120.

The first transparent electrode 120-1, the second transparent electrode 120-2, and the first alignment film 130-1 covering the first transparent electrode 120-1 and the second transparent electrode 120-2 are provided on the first substrate 110-1. The third transparent electrode 120-3, the fourth transparent electrode 120-4, and the second alignment film 130-2 covering the third transparent electrode 120-3 and the fourth transparent electrode 120-4 are provided on the second substrate 110-2. The first substrate 110-1 and the second substrate 110-2 are disposed such that the first transparent electrode 120-1 and the second transparent electrode 120-2 on the first substrate 110-1 face the third transparent electrode 120-3 and the fourth transparent electrode 120-4 on the second substrate 110-2. The first substrate 110-1 and the second substrate 110-2 are bonded to each other via the sealing member 140 provided on the periphery of the first substrate 110-1 and the second substrate 110-2. A liquid crystal is sealed in a space surrounded by the first substrate 110-1 (more specifically, the first alignment film 130-1), the second substrate 110-2 (more specifically, the second alignment film 130-2), and the sealing member 140 to provide the liquid crystal layer 150 between the first substrate 110-1 and the second substrate 110-2.

For example, a rigid substrate having light-transmitting properties such as a glass substrate, a quartz substrate, or a sapphire substrate is used as each of the first substrate 110-1 and the second substrate 110-2. Further, a flexible substrate having light-transmitting properties such as a polyimide resin substrate, an acrylic resin substrate, a siloxane resin substrate, or a fluorine resin substrate can also be used as each of the first substrate 110-1 and the second substrate 110-2.

Each of the first transparent electrode 120-1, the second transparent electrode 120-2, the third transparent electrode 120-3, and the fourth transparent electrode 120-4 functions as an electrode for forming an electric field in the liquid crystal layer 150. For example, a transparent conductive material such as indium tin oxide (ITO) or indium zinc oxide (IZO) is used for each of the first transparent electrode 120-1, the second transparent electrode 120-2, the third transparent electrode 120-3, and the fourth transparent electrode 120-4. Further, a non-transparent metal material is used for each of the first transparent electrode 120-1, the second transparent electrode 120-2, the third transparent electrode 120-3, and the fourth transparent electrode 120-4.

Although details of a planar pattern of each of the first transparent electrode 120-1, the second transparent electrode 120-2, the third transparent electrode 120-3, and the fourth transparent electrode 120-4 are described later, the first transparent electrode 120-1 and the second transparent electrode 120-2 extend substantially along the x-axis direction, and the third transparent electrode 120-3 and the fourth transparent electrode 120-4 extend substantially along the y-axis direction, as shown in FIGS. 4A and 4B.

The liquid crystal layer 150 can refract transmitted light or change the polarization state of transmitted light according to the alignment state of the liquid crystal molecules. For example, nematic liquid crystal can be used as the liquid crystal of the liquid crystal layer 150. Although a positive liquid crystal is described as the liquid crystal in the present embodiment, a negative liquid crystal can also be adopted by changing the initial alignment directions of the liquid crystal molecules. Further, the liquid crystal preferably contains a chiral agent that imparts twist to the liquid crystal molecules.

Each of the first alignment film 130-1 and the second alignment film 130-2 aligns the liquid crystal molecules in the liquid crystal layer 150 in a predetermined direction. For example, a polyimide resin or the like can be used for each of the first alignment film 130-1 and the second alignment film 130-2. In addition, each of the first alignment film 130-1 and the second alignment film 130-2 may be imparted with alignment properties by an alignment treatment such as a rubbing method or a photo-alignment method. The rubbing method is a method of rubbing the surface of the alignment film in one direction. The photo-alignment method is a method of irradiating an alignment film with linearly polarized ultraviolet rays.

A rubbing treatment is performed on the first alignment film 130-1 in the y-axis direction, and the first alignment film 130-1 has an alignment characteristic that aligns the long axes of the liquid crystal molecules on the side of the first substrate 110-1 of the liquid crystal layer 150 in the y-axis direction. Further, a rubbing treatment is performed on the second alignment film 130-2 in the x-axis direction, and the second alignment film 130-2 has an alignment characteristic that aligns the long axes of the liquid crystal molecules on the side of the second substrate 110-2 of the liquid crystal layer 150 in the x-axis direction.

In addition, although the alignment direction (y-axis direction) of the first alignment film 130-1 and the alignment direction (x-axis direction) of the second alignment film 130-2 are described as being orthogonal to each other in the present embodiment, the angle between the alignment direction of the first alignment film 130-1 and the alignment direction of the second alignment film 130-2 is not limited to 90 degrees. The angle between the alignment direction of the first alignment film 130-1 and the alignment direction of the second alignment film 130-2 may be an angle close to 90 degrees, for example, an angle greater than or equal to 80 degrees and less than 90 degrees.

An adhesive material containing epoxy resin, acrylic resin, or the like can be used for the sealing member 140. The adhesive material may be an ultraviolet curable type or a heat curable type.

Although the configuration of the first liquid crystal cell 100-1 is described above, the four liquid crystal cells having the same configuration are stacked with their arrangement directions changed from one another in the optical element 10. Specifically, the second liquid crystal cell 100-2 is disposed on the first liquid crystal cell 100-1 so that the first substrate 110-1 of the second liquid crystal cell 100-2 faces the second substrate 110-2 of the first liquid crystal cell 100-1. The third liquid crystal cell 100-3 is disposed on the second liquid crystal cell 100-2 so that the second substrate 110-2 of the third liquid crystal cell 100-3 faces the second substrate of the second liquid crystal cell 100-2. The fourth liquid crystal cell 100-4 is disposed on the third liquid crystal cell 100-3 so that the second substrate of the fourth liquid crystal cell 100-4 faces the first substrate 110-1 of the third liquid crystal cell.

### [3. Characteristics of Liquid Crystal Cell]

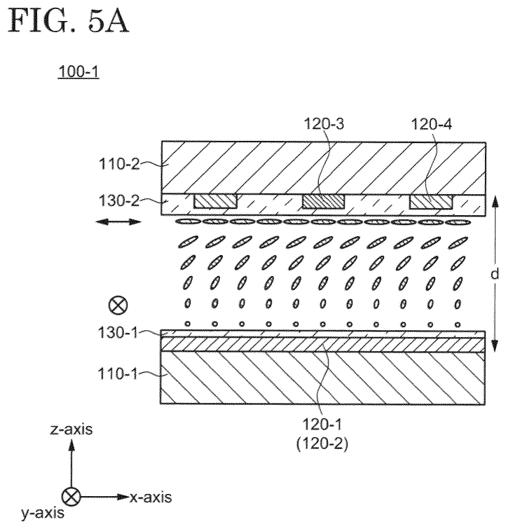

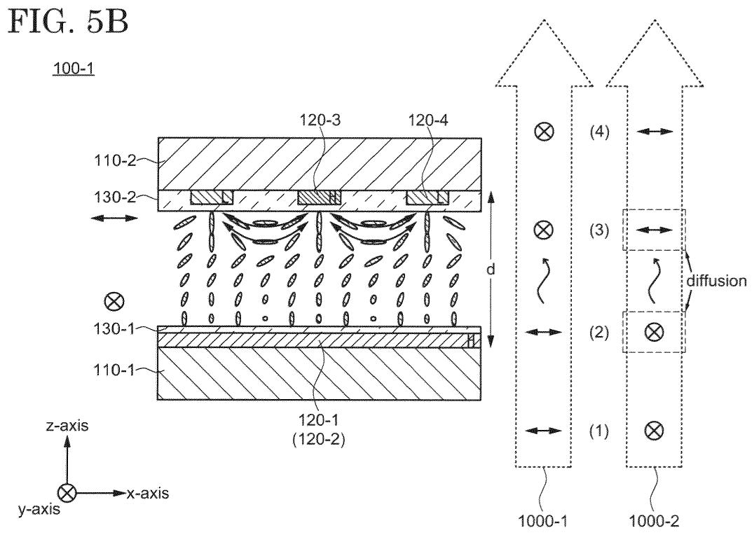

Here, the properties of light passing through the first liquid crystal cell 100-1 are described with reference to FIGS. 5A and 5B.

FIGS. 5A and 5B are schematic cross-sectional views illustrating the properties of light passing through the first liquid crystal cell 100-1 of the optical device 1 according to an embodiment of the present invention. Specifically, FIG. 5A shows the first liquid crystal cell 100-1 in a state where no voltage is applied to the transparent electrodes 120, and FIG. 5B shows the first liquid crystal cell 100-1 in a state where voltages are applied to the transparent electrodes 120.

As shown in FIG. 5A, when no voltage is applied to any of the first transparent electrode 120-1, the second transparent electrode 120-2, the third transparent electrode 120-3, and the fourth transparent electrode 120-4, the liquid crystal molecules in the liquid crystal layer 150 are aligned so as to be twisted 90 degrees along the z-axis direction as they move from the first substrate 110-1 to the second substrate 110-2. Therefore, the polarization plane (the direction of the polarization axis or the polarization component) of the light passing through the liquid crystal layer 150 is rotated 90 degrees in accordance with the alignment direction of the liquid crystal molecules. In other words, the light passing through the liquid crystal layer 150 has optical rotation.

In FIG. 5B, voltages are applied so as to generate a potential difference between two adjacent transparent electrodes 120. For example, a high voltage (H) is applied to the first transparent electrode 120-1 and the third transparent electrode 120-3, and a low voltage (L) is applied to the second transparent electrode 120-2 and the fourth transparent electrode 120-4. In the following description, the electric field generated between two adjacent transparent electrodes 120 may be referred to as a lateral electric field.

The liquid crystal molecules closer to the first substrate 110-1 are aligned in a convex arc shape in the y-axis direction with respect to the first substrate 110-1 by the lateral electric field between the first transparent electrode 120-1 and the second transparent electrode 120-2, and a refractive index distribution is generated. The liquid crystal molecules closer to the second substrate 110-2 are aligned in a convex arc shape in the x-axis direction with respect to the second substrate 110-2 by the lateral electric field between the third transparent electrode 120-3 and the fourth transparent electrode 120-4, and a refractive index distribution is generated. On the other hand, since a cell gap d, which is a distance between the first substrate 110-1 and the second substrate 110-2, is sufficiently larger (for example, 10 μm≤d≤30 μm) than the distance between the two adjacent transparent electrodes, the alignment of the liquid crystal molecules located in the vicinity of the center between the first substrate 110-1 and the second substrate 110-2 hardly changes.

The light emitted from the light source 20 includes a polarized component in the x-axis direction (hereinafter, referred to as a “P-polarization component”) and a polarized component in the y-axis direction (hereinafter, referred to as an “S-polarization component”). However, in the following description, the light emitted from the light source 20 is described as being divided into a first polarized light 1000-1 having the P-polarization component and a second polarized light 1000-2 having the S-polarization component, for convenience (see (1) in FIG. 5B).

Since the P-polarization component of the first polarized light 1000-1 incident on the liquid crystal cell 100 is different from the alignment direction of the liquid crystal molecules on the side of the first substrate 110-1, the first polarized light 1000-1 is not diffused (see (2) in FIG. 5B). In the process of passing through the liquid crystal layer 150, the alignment of the polarization component of the first polarized light 1000-1 rotates by the angle (90 degrees in the present embodiment) between the alignment direction of the first alignment film 130-1 and the second alignment film 130-2 (this phenomenon may be referred to as an optical rotation), and the polarization component changes from the P-polarization component to the S-polarization component. Since the S-polarization component of the first polarized light 1000-1 is different from the alignment direction of the liquid crystal molecules on the side of the second substrate 110-2, the first polarized light 1000-1 is not diffused (see (3) in FIG. 5B). Further, the first polarized light 1000-1 emitted from the liquid crystal cell 100 has the S-polarization component (see (4) in FIG. 5B).

On the other hand, since the S-polarization component of the second polarized light 1000-2 incident on the liquid crystal cell 100 is aligned in the same direction as the alignment direction of the liquid crystal molecules on the side of the first substrate 110-1, the second polarized light 1000-2 is diffused in the y-axis direction according to the refractive index distribution of the liquid crystal molecules (see (2) in FIG. 5B). The second polarized light 1000-2 is rotated while passing through the liquid crystal layer 150, and the polarization component changes from the S-polarization component to the P-polarization component. Since the P-polarization component of the second polarized light 1000-2 is aligned in the same direction as the alignment direction of the liquid crystal molecules on the side of the second substrate 110-2, the second polarized light 1000-2 is diffused in the x-axis direction according to the refractive index distribution of the liquid crystal molecules (see (3) in FIG. 5B). Further, the second polarized light 1000-2 emitted from the liquid crystal cell 100 has the P-polarization component (see (4) in FIG. 5B).

Although the characteristics of the first liquid crystal cell 100-1 are described above, the four liquid crystal cells having the same configuration are stacked with their arrangement directions changed from one another in the optical element 10. The diffusion characteristics of the first liquid crystal cell 100-1, the second liquid crystal cell 100-2, the third liquid crystal cell 100-3, and the fourth liquid crystal cell 100-4 for the P-polarization component and the S-polarization component of the light emitted from the light source 20 are shown in Table 1. In addition, Table 1 shows the case where voltages are applied to all the transparent electrodes 120 (i.e., a potential difference is generated between two adjacent transparent electrodes 120 on the substrate 110).

TABLE 1

| | P-polarization component | S-polarization component |
|---|---|---|
| | of light from light source 20 | of light from light source 20 |
| Fourth Liquid | no diffusion | diffusion |
| Crystal Cell | | |
| 100-4 | | |
| Third Liquid | diffusion | no diffusion |
| Crystal Cell | | |
| 100-3 | | |
| Second Liquid | diffusion | no diffusion |
| Crystal Cell | | |
| 100-4 | | |
| First Liquid | no diffusion | diffusion |
| Crystal Cell | | |
| 100-1 | | |

### [4. Planar Pattern of Transparent Electrodes]

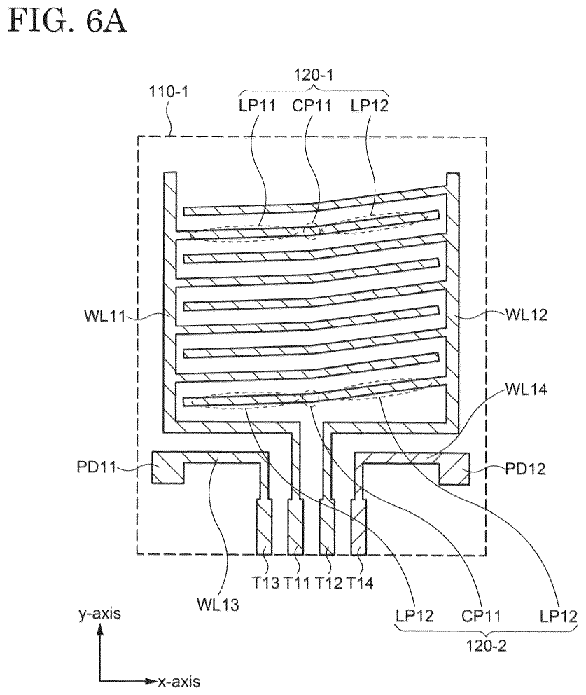

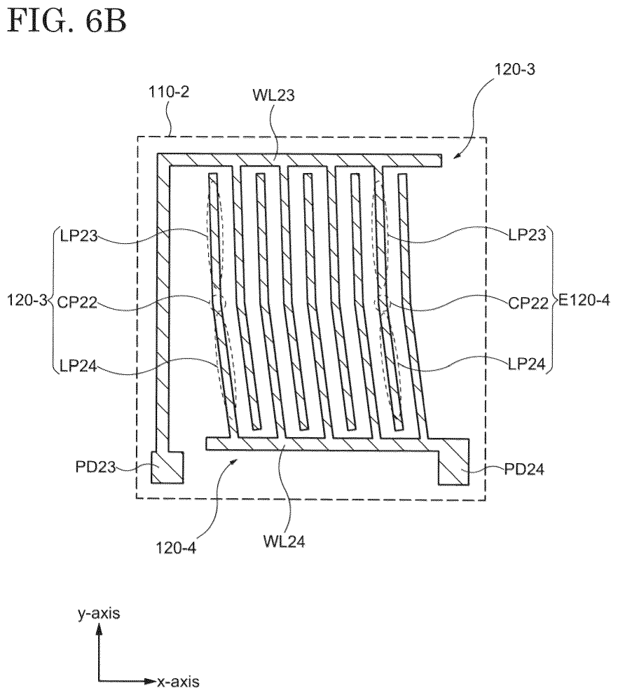

FIGS. 6A and 6B are schematic plan views showing planar patterns including the transparent electrodes 120 of the first liquid crystal cell 100-1 of the optical device 1 according to an embodiment of the present invention. Specifically, FIG. 6A shows a planar pattern including the first transparent electrode 120-1 and the second transparent electrode 120-2 on the first substrate 110-1, and FIG. 6B shows a planar pattern including the third transparent electrode 120-3 and the fourth transparent electrode 120-4 on the second substrate 110-2.

As shown in FIG. 6A, the plurality of first transparent electrodes 120-1, the plurality of second transparent electrodes 120-2, a wiring WL11, a wiring WL12, a first connection terminal T11, and a second connection terminal T12 are provided on the first substrate 110-1. Each of the plurality of first transparent electrodes 120-1 is electrically connected to the first connection terminal T11 through the wiring WL11. Further, each of the plurality of second transparent electrodes 120-2 is electrically connected to the second connection terminal T12 through the wiring WL12. Furthermore, a third connection terminal T13, a fourth connection terminal T14, a wiring WL13, a wiring WL14, a first connection pad PD11, and a second connection pad PD12 are provided on the first substrate 110-1. The first connection pad PD11 is electrically connected to the third connection terminal T13 through the wiring WL13. The second connection pad PD12 is electrically connected to the fourth connection terminal T14 through the wiring WL14.

Flexible printed circuits are connected to the first connection terminal T11, the second connection terminal T12, the third connection terminal T13, and the fourth connection terminal T14, and voltages that correspond to a control signal for controlling the first liquid crystal cell 100-1 are supplied to the first connection terminal T11, the second connection terminal T12, the third connection terminal T13, and the fourth connection terminal T14.

A transparent conductive material or a metal material may be used for the wiring WL11, the wiring WL12, the wiring WL13, the wiring WL14, the first connection pad PD11, the second connection pad PD12, the first connection terminal T11, the second connection terminal T12, the third connection terminal T13, and the fourth connection terminal T14.

Each of the plurality of first transparent electrodes 120-1 includes a first straight line portion LP11, a second straight line portion LP12, and a first bent portion CP11. The first straight line portion LP11 and the second straight line portion LP12 are not parallel to each other, and they are connected to each other at a predetermined angle formed therebetween at the first bent portion CP11. Similarly, each of the plurality of second transparent electrodes 120-2 also includes a first straight line portion LP11, a second straight line portion LP12, and a first bent portion CP11. However, in the first transparent electrode 120-1, the first straight line portion LP11 is connected to the wiring WL11, and the second straight line portion LP12 has an end portion, whereas in the second transparent electrode 120-2, the second straight line portion LP12 is connected to the wiring WL12, and the first straight line portion LP11 has an end portion. In this aspect, the first transparent electrode 120-1 and the second transparent electrode 120-2 are different from each other in configuration.

As shown in FIG. 6B, the plurality of third transparent electrodes 120-3, the plurality of fourth transparent electrodes 120-4, a wiring WL23, a wiring WL24, a third connection pad PD23, and a fourth connection pad PD24 are provided on the second substrate 110-2. Each of the plurality of third transparent electrodes 120-3 is electrically connected to the third connection pad PD23 through the wiring WL23. Further, each of the plurality of fourth transparent electrodes 120-4 is electrically connected to the fourth connection pad PD24 through the wiring WL24. The third connection pad PD23 and the fourth connection pad PD24 are electrically connected to the first connection pad PD11 and the second connection pad PD12, respectively, by a conductive material. Therefore, each of the plurality of third transparent electrodes 120-3 is electrically connected to the third connection terminal T13, and each of the plurality of fourth transparent electrodes 120-4 is electrically connected to the fourth connection terminal T14.

Each of the plurality of third transparent electrodes 120-3 includes a third straight line portion LP23, a fourth straight line portion LP24, and a second bent portion CP22. The third straight line portion LP23 and the fourth straight line portion LP24 are not parallel to each other, and they are connected to each other at a predetermined angle formed therebetween at the second bent portion CP22. Similarly, each of the plurality of fourth transparent electrodes 120-4 also includes a third straight line portion LP23, a fourth straight line portion LP24, and a second bent portion CP22. However, in the third transparent electrode 120-3, the third straight line portion LP23 is connected to the wiring WL23, and the fourth straight line portion LP24 has an end portion, whereas in the fourth transparent electrode 120-4, the fourth straight line portion LP24 is connected to the wiring WL24, and the third straight line portion LP23 has an end portion. In this aspect, the third transparent electrode 120-3 and the fourth transparent electrode 120-4 are different from each other in configuration.

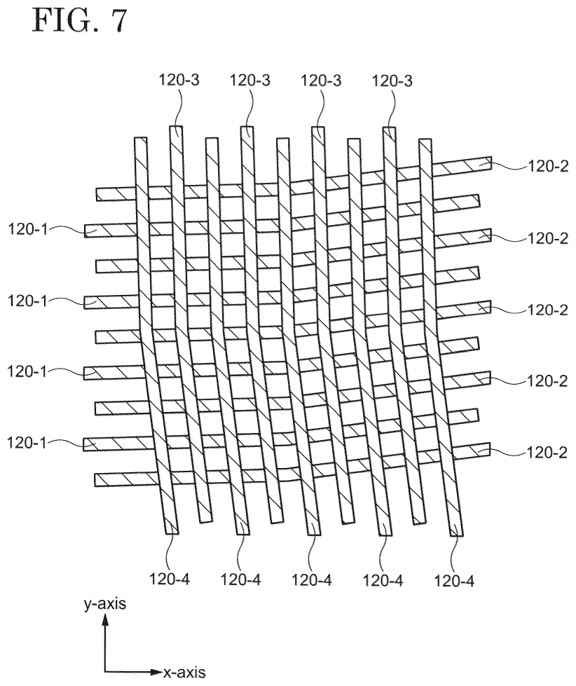

FIG. 7 is a plan view showing a planar pattern of the transparent electrodes 120 of the first liquid crystal cell 100-1 of the optical device 1 according to an embodiment of the present invention. In a plan view, the first transparent electrode 120-1, the second transparent electrode 120-2, the third transparent electrode 120-3, and the fourth transparent electrode 120-4 each have a dogleg shape. The third transparent electrode 120-3 overlaps the first transparent electrode 120-1 and the second transparent electrode 120-2. Similarly, the fourth transparent electrode 120-4 also overlaps the first transparent electrode 120-1 and the second transparent electrode 120-2.

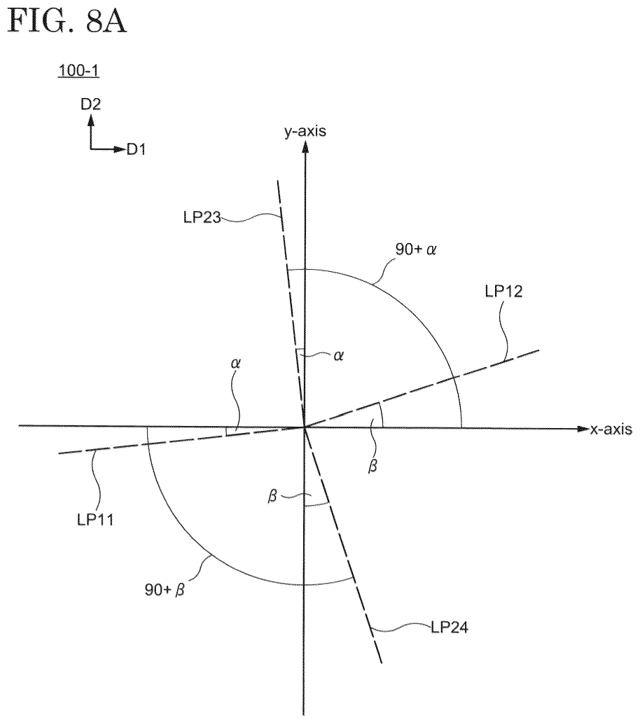

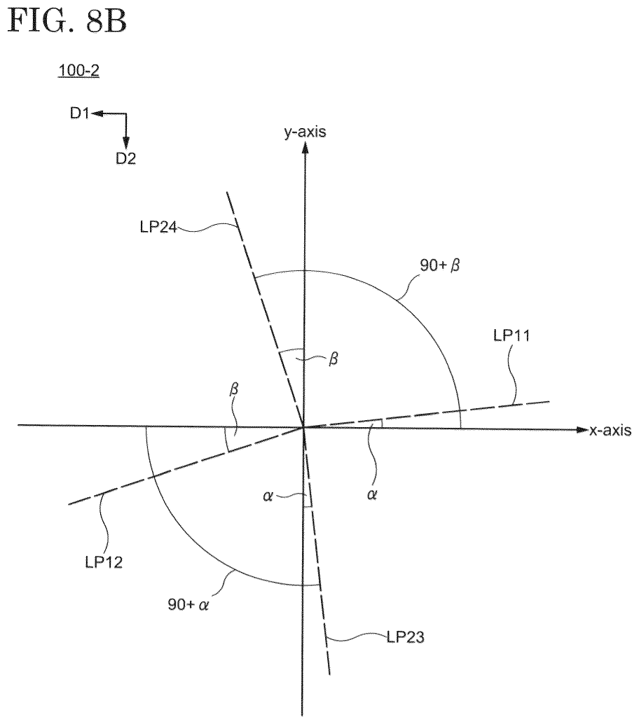

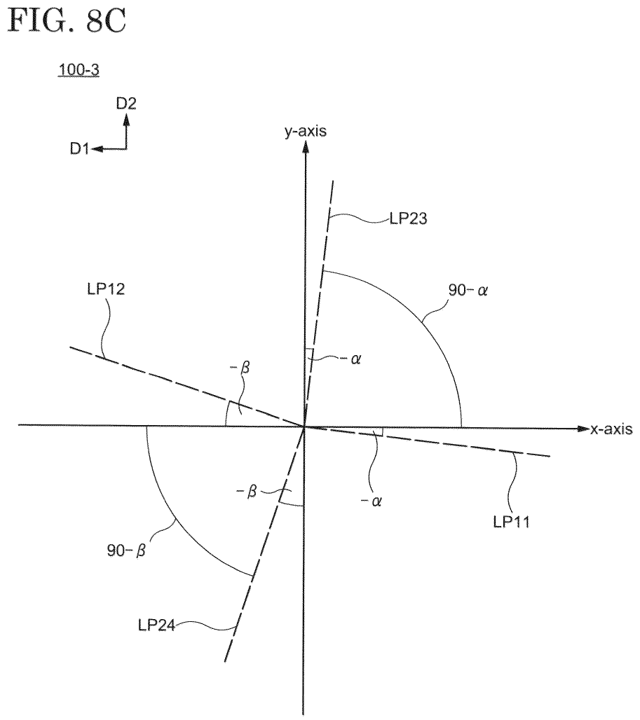

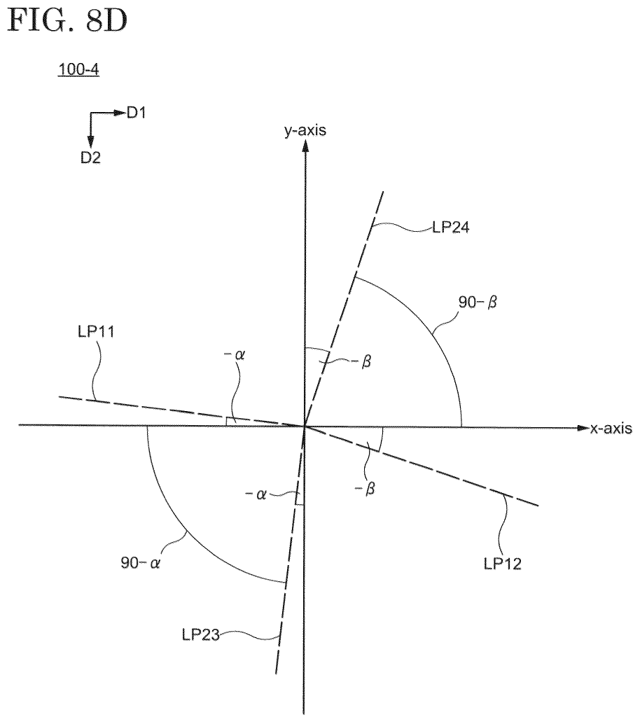

Here, extending directions of the first straight line portion LP11, the second straight line portion LP12, the third straight line portion LP23, and the fourth straight line portion LP24 of the transparent electrodes 120 are described with reference to FIGS. 8A to 8D.

FIG. 8A is a schematic diagram illustrating angles of the extending directions of the transparent electrodes 120 of the first liquid crystal cell 100-1 of the optical device 1 according to an embodiment of the present invention. FIG. 8A shows the extending directions of the first straight line portion LP11, the second straight line portion LP12, the third straight line portion LP23, and the fourth straight line portion LP24 of the first liquid crystal cell 100-1 in the xy coordinates with the first bent portion CP11 and the second bent portion CP22 as the origin. In the present specification, the center line in the length direction of the straight line portion is defined as the extending direction, for convenience of explanation.

In the first liquid crystal cell 100-1, the first straight line portion LP11 extends at an angle of α degrees (0<α<90) with respect to the x-axis direction. The second straight line portion LP12 extends at an angle of β degrees (0<β<90 and β≠α) with respect to the x-axis direction. The third straight line portion LP23 extends at an angle of (90+α) degrees with respect to the x-axis direction. The fourth straight line portion LP24 extends at an angle of (90+β) degrees with respect to the x-axis direction.

Here, when the xy coordinates shown in FIG. 8A are divided into a first quadrant, a second quadrant, a third quadrant, and a fourth quadrant, the second straight line portion LP12, the third straight line portion LP23, the first straight line portion LP11, and the fourth straight line portion LP24 belong to the first quadrant, the second quadrant, the third quadrant, and the fourth quadrant, respectively. That is, the first straight line portion LP11, the second straight line portion LP12, the third straight line portion LP23, and the fourth straight line portion LP24 belong to mutually different quadrants in a plan view of the first liquid crystal cell 100-1.

FIG. 8B is a schematic diagram illustrating angles of the extending directions of the transparent electrodes 120 of the second liquid crystal cell 100-2 of the optical device 1 according to an embodiment of the present invention. FIG. 8B shows the extending directions of the first straight line portion LP11, the second straight line portion LP12, the third straight line portion LP23, and the fourth straight line portion LP24 of the second liquid crystal cell 100-2 in the xy coordinates with the first bent portion CP11 and the second bent portion CP22 as the origin.

In the second liquid crystal cell 100-2, the first straight line portion LP11 extends at an angle of α degrees with respect to the x-axis direction. The second straight line portion LP12 extends at an angle of β degrees with respect to the x-axis direction. The third straight line portion LP23 extends at an angle of (90+α) degrees with respect to the x-axis direction. The fourth straight line portion LP24 extends at an angle of (90+β) degrees with respect to the x-axis direction. In the second liquid crystal cell 100-2, the first straight line portion LP11, the fourth straight line portion LP24, the second straight line portion LP12, and the third straight line portion LP23 belong to the first quadrant, the second quadrant, the third quadrant, and the fourth quadrant, respectively. That is, the first straight line portion LP11, the second straight line portion LP12, the third straight line portion LP23, and the fourth straight line portion LP24 belong to different quadrants, also in a plan view of the second liquid crystal cell 100-2.

FIG. 8C is a schematic diagram illustrating angles of the extending directions of the transparent electrodes 120 of the third liquid crystal cell 100-3 of the optical device 1 according to an embodiment of the present invention. FIG. 8C shows the extending directions of the first straight line portion LP11, the second straight line portion LP12, the third straight line portion LP23, and the fourth straight line portion LP24 of the third liquid crystal cell 100-3 in the xy coordinates with the first bent portion CP11 and the second bent portion CP22 as the origin.

In the third liquid crystal cell 100-3, the first straight line portion LP11 extends at an angle of −α degrees with respect to the x-axis direction. The second straight line portion LP12 extends at an angle of −β degrees with respect to the x-axis direction. The third straight line portion LP23 extends at an angle of (90−α) degrees with respect to the x-axis direction. The fourth straight line portion LP24 extends at an angle of (90−β) degrees with respect to the x-axis direction. In the third liquid crystal cell 100-3, the third straight line portion LP23, the second straight line portion LP12, the fourth straight line portion LP24, and the first straight line portion LP11 belong to the first quadrant, the second quadrant, the third quadrant, and the fourth quadrant, respectively. That is, the first straight line portion LP11, the second straight line portion LP12, the third straight line portion LP23, and the fourth straight line portion LP24 belong to different quadrants, also in a plan view of the third liquid crystal cell 100-3.

FIG. 8D is a schematic diagram illustrating angles of the extending direction of the transparent electrodes 120 of the fourth liquid crystal cell 100-4 of the optical device 1 according to an embodiment of the present invention. FIG. 8D shows the extending directions of the first straight line portion LP11, the second straight line portion LP12, the third straight line portion LP23, and the fourth straight line portion LP24 of the fourth liquid crystal cell 100-4 in the xy coordinates with the first bent portion CP11 and the second bent portion CP22 as the origin.

In the fourth liquid crystal cell 100-4, the first straight line portion LP11 extends at an angle of −α degrees with respect to the x-axis direction. The second straight line portion LP12 extends at an angle of −β° with respect to the x-axis direction. The third straight line portion LP23 extends at an angle of (90−α) degrees with respect to the x-axis direction. The fourth straight line portion LP24 extends at an angle of (90−β) degrees with respect to the x-axis direction. In the fourth liquid crystal cell 100-4, the fourth straight line portion LP24, the first straight line portion LP11, the third straight line portion LP23, and the second straight line portion LP12 belong to the first quadrant, the second quadrant, the third quadrant, and the fourth quadrant, respectively. That is, the first straight line portion LP11, the second straight line portion LP12, the third straight line portion LP23, and the fourth straight line portion LP24 belong to different quadrants, also in a plan view of the fourth liquid crystal cell 100-4.

Table 2 shows the straight line portions belonging to each quadrant in the first liquid crystal cell 100-1, the second liquid crystal cell 100-2, the third liquid crystal cell 100-3, and the fourth liquid crystal cell 100-4. Table 3 shows the angles formed with the x-axis direction by the straight line portions belonging to each quadrant in the first liquid crystal cell 100-1, the second liquid crystal cell 100-2, the third liquid crystal cell 100-3, and the fourth liquid crystal cell 100-4.

TABLE 2

| | First | Second | Third | Fourth |
|---|---|---|---|---|
| | Quadrant | Quadrant | Quadrant | Quadrant |
| Fourth Liquid | fourth | first | third | second |
| Crystal Cell | straight | straight | straight | straight |
| 100-4 | portion | portion | portion | portion |
| | LP24 | LP11 | LP23 | LP12 |
| Third Liquid | third | second | fourth | first |
| Crystal Cell | straight | straight | straight | straight |
| 100-3 | portion | portion | portion | portion |
| | LP23 | LP12 | LP24 | LP11 |
| Second Liquid | first | fourth | second | third |
| Crystal Cell | straight | straight | straight | straight |
| 100-2 | portion | portion | portion | portion |
| | LP11 | LP24 | LP12 | LP23 |
| First Liquid | second | third | first | fourth |
| Crystal Cell | straight | straight | straight | straight |
| 100-1 | portion | portion | portion | portion |
| | LP12 | LP23 | LP11 | LP24 |

TABLE 3

| | First | Second | Third | Fourth |
|---|---|---|---|---|
| | Quadrant | Quadrant | Quadrant | Quadrant |
| Fourth Liquid | (90 − β) degrees | −α degrees | (90 − α) degrees | −β degrees |
| Crystal Cell | | | | |
| 100-4 | | | | |
| Third Liquid | (90 − α) degrees | −β degrees | (90 − β) degrees | −α degrees |
| Crystal Cell | | | | |
| 100-3 | | | | |
| Second Liquid | α degrees | (90 + β) degrees | β degrees | (90 + α) degrees |
| Crystal Cell | | | | |
| 100-2 | | | | |
| First Liquid | β degrees | (90 + α) degrees | α degrees | (90 + β) degrees |
| Crystal Cell | | | | |
| 100-1 | | | | |

As can be seen from Tables 2 and 3, even when the first liquid crystal cell 100-1, the second liquid crystal cell 100-2, the third liquid crystal cell 100-3, and the fourth liquid crystal cell 100-4 are stacked in the optical element 10, the straight line portions belong to each quadrant, and the straight line portions in each quadrant overlap each other with a shifted angle. Therefore, moire is reduced in the optical element 10. The angles α degrees and β degrees are preferably greater than 0 degrees and less than or equal to 45 degrees, more preferably greater than 0 degrees and less than or equal to 30 degrees, and particularly preferably greater than 0 degrees and less than or equal to 10 degrees.

Although the angles of the extending directions of the transparent electrodes 120 with the bent portion as the origin in the xy coordinates are described above, the angles can also be defined with a base portion of the transparent electrode 120 (i.e., a connection portion between the transparent electrode 120 and the wiring) as the center. In this case, it can be said that the two straight line portions included in one transparent electrode 120 are bent at a predetermined angle in the same direction (positive or negative direction) from the x-axis direction or the y-axis direction.

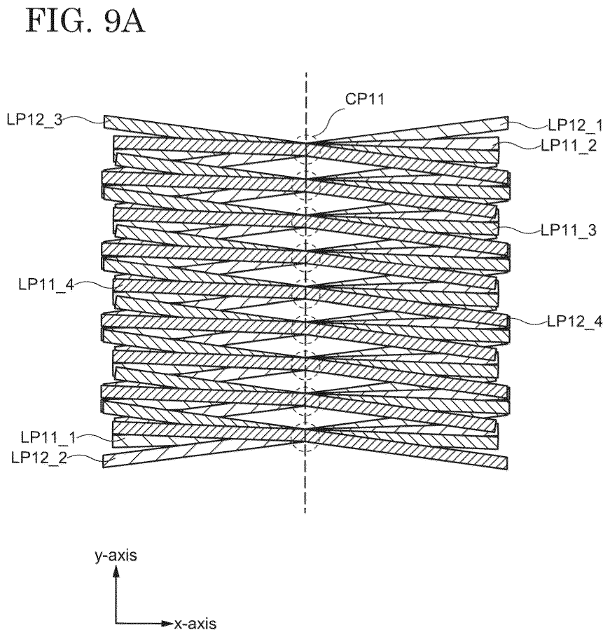

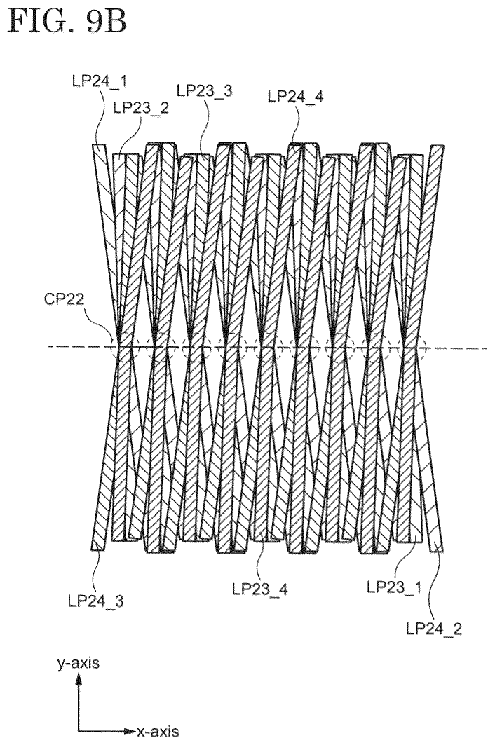

Here, positions of the bent portions are described with reference to FIGS. 9A and 9B.

FIGS. 9A and 9B are schematic plan views showing the overlapping state of transparent electrodes 120 extending along the x-axis direction and the y-axis direction, respectively, in an optical device 1 according to an embodiment of the present invention. Although the straight line portions of the transparent electrodes 120 extend at a predetermined angle with respect to the x-axis direction as described above, the first transparent electrode 120-1 and the second transparent electrode 120-2 extend substantially along the x-axis direction in FIG. 9A, and the third transparent electrode 120-3 and the fourth transparent electrode 120-4 extend substantially along the y-axis direction in FIG. 9B.

As shown in FIG. 9A, the first straight line portion LP11_1 and the second straight line portion LP12_1 of the first liquid crystal cell 100-1, the first straight line portion LP11_2 and the second straight line portion LP12_2 of the second liquid crystal cell 100-2, the first straight line portion LP11_3 and the second straight line portion LP12_3 of the third liquid crystal cell 100-3, and the first straight line portion LP11_4 and the second straight line portion LP12_4 of the fourth liquid crystal cell 100-4 do not completely overlap each other when viewed along the length direction. However, the first bent portions CP11 included in the first liquid crystal cell 100-1, the second liquid crystal cell 100-2, the third liquid crystal cell 100-3, and the fourth liquid crystal cell 100-4 are on a straight line extending in the y-axis direction in a plan view.

As shown in FIG. 9B, the third straight line portion LP23_1 and the fourth straight line portion LP24_1 of the first liquid crystal cell 100-1, the third straight line portion LP23_2 and the fourth straight line portion LP24_2 of the second liquid crystal cell 100-2, the third straight line portion LP23_3 and the fourth straight line portion LP24_3 of the third liquid crystal cell 100-3, and the third straight line portion LP23_4 and the fourth straight line portion LP24_4 of the fourth liquid crystal cell 100-4 do not completely overlap each other when viewed along the length direction. However, the second bent portions CP22 included in the first liquid crystal cell 100-1, the second liquid crystal cell 100-2, the third liquid crystal cell 100-3, and the fourth liquid crystal cell 100-4 are on a straight line extending in the x-axis direction in a plan view.

### [5. Another Configuration of Optical Element]

In the liquid crystal cell 100 including the transparent electrodes 120 having the above-described planar patterns, an optical element 10A different from the optical element 10 can also be manufactured by using a plurality of liquid crystal cells 100 having the same configuration.

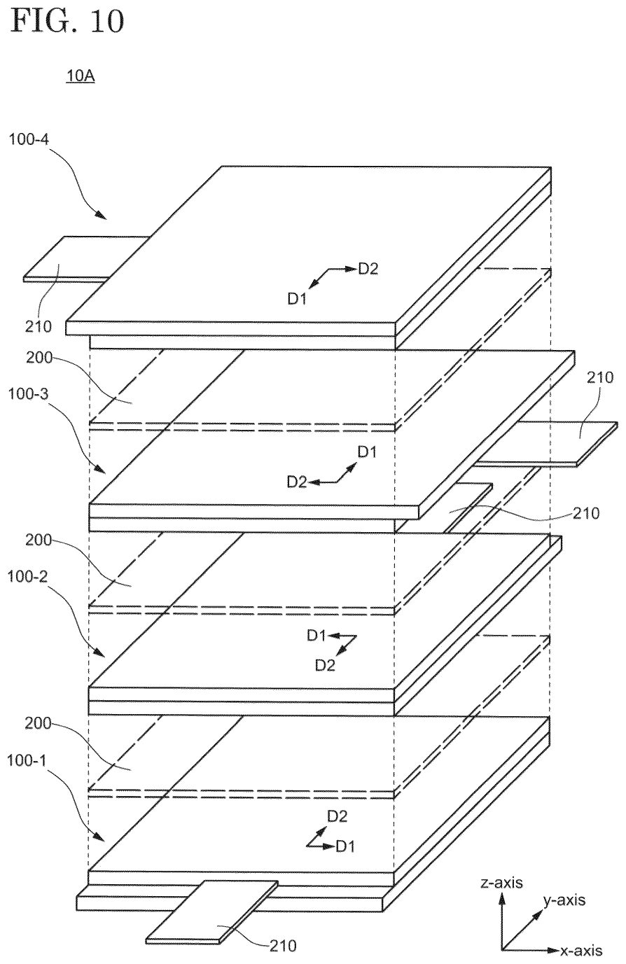

FIG. 10 is a schematic exploded perspective view of the optical element 10A of an optical device 1 according to an embodiment of the present invention. The optical element 10A differs from the optical element 10 in the arrangement directions of the third liquid crystal cell 100-3 and the fourth liquid crystal cell 100-4.

In the optical element 10A, the first direction D1 and the second direction D2 of the third liquid crystal cell 100-3 are the +y direction and the −x direction, respectively. In other words, the third liquid crystal cell 100-3 is disposed on the second liquid crystal cell 100-2 such that the angle between the first direction D1 of the first liquid crystal cell 100-1 and the first direction D1 of the third liquid crystal cell 100-3 is 90 degrees, and the angle between the second direction D2 of the first liquid crystal cell 100-1 and the second direction D2 of the third liquid crystal cell 100-3 is 90 degrees. The first direction D1 and the second direction D2 of the fourth liquid crystal cell 100-4 are the −y direction and the +x direction, respectively. In other words, the fourth liquid crystal cell 100-4 is arranged on the third liquid crystal cell 100-3 such that the angle between the first direction D1 of the first liquid crystal cell 100-1 and the first direction D1 of the fourth liquid crystal cell 100-4 is 90 degrees, and the angle between the first direction D1 of the first liquid crystal cell 100-1 and the first direction D1 of the fourth liquid crystal cell 100-4 is 90 degrees.

The diffusion characteristics of each of the first liquid crystal cell 100-1, the second liquid crystal cell 100-2, the third liquid crystal cell 100-3, and the fourth liquid crystal cell 100-4 in the optical element 10A are shown in Table 4. In addition, Table 4 shows the case where voltages are applied to all the transparent electrodes 120 (i.e., a potential difference occurs between two adjacent transparent electrodes 120 on the substrate 110).

TABLE 4

| | P-polarization component | S-polarization component |
|---|---|---|
| | of light from light source 20 | of light from light source 20 |
| Fourth Liquid | diffusion | no diffusion |
| Crystal Cell | | |
| 100-4 | | |
| Third Liquid | no diffusion | diffusion |
| Crystal Cell | | |
| 100-3 | | |
| Second Liquid | diffusion | no diffusion |
| Crystal Cell | | |
| 100-4 | | |
| First Liquid | no diffusion | diffusion |
| Crystal Cell | | |
| 100-1 | | |

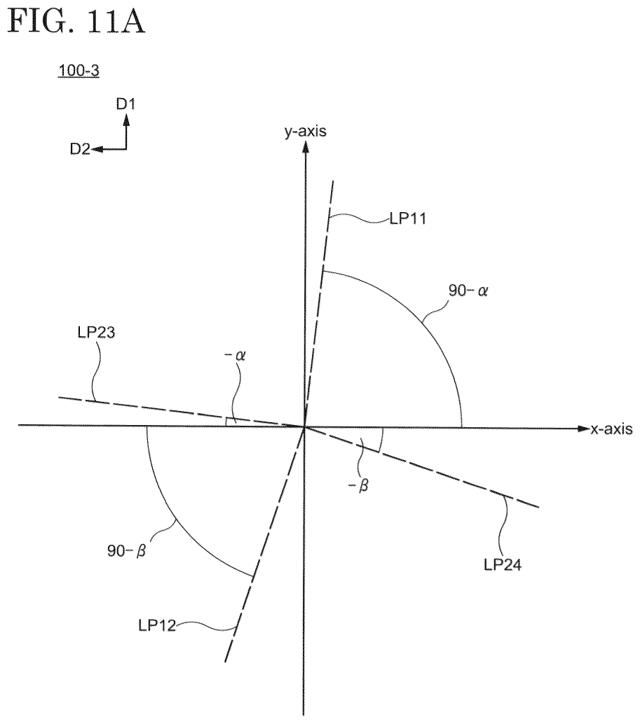

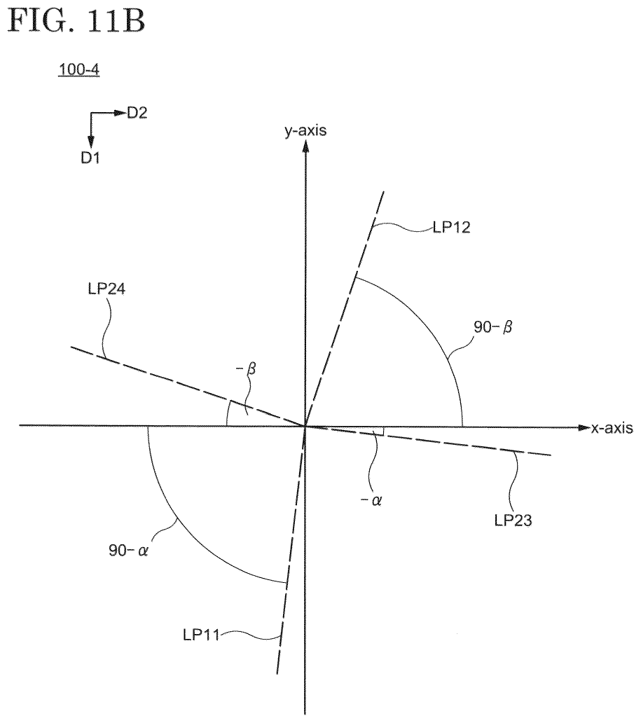

FIG. 11A is a schematic diagram illustrating angles of the extending directions of the transparent electrodes 120 of the third liquid crystal cell 100-3 of the optical element 10A included in the optical device 1 according to an embodiment of the present invention. FIG. 11A shows the first straight line portion LP11, the second straight line portion LP12, the third straight line portion LP23, and the fourth straight line portion LP24 of the third liquid crystal cell 100-3 of the optical element 10A in the xy coordinates with the first bent portion CP11 and the second bent portion CP22 as the origin.

In the third liquid crystal cell 100-3 of the optical element 10A, the first straight line portion LP11 extends at an angle of (90−α) degrees with respect to the x-axis direction. The second straight line portion LP12 extends at an angle of (90−β) degrees with respect to the x-axis direction. The third straight line portion LP23 extends at an angle of −α degrees with respect to the x-axis direction. The fourth straight line portion LP24 extends at an angle of −β degrees with respect to the x-axis direction. In the third liquid crystal cell 100-3 of the optical element 10A, the first straight line portion LP11, the third straight line portion LP23, the second straight line portion LP12, and the fourth straight line portion LP24 belong to the first quadrant, the second quadrant, the third quadrant, and the fourth quadrant, respectively. That is, the first straight line portion LP11, the second straight line portion LP12, the third straight line portion LP23, and the fourth straight line portion LP24 belong to different quadrants in a plan view of the third liquid crystal cell 100-3 of the optical element 10A.

FIG. 11B is a schematic diagram illustrating angles of the extending directions of the transparent electrode 120 of the fourth liquid crystal cell 100-4 of the optical element 10A included in the optical device 1 according to an embodiment of the present invention. FIG. 11B shows the first straight line portion LP11, the second straight line portion LP12, the third straight line portion LP23, and the fourth straight line portion LP24 of the fourth liquid crystal cell 100-4 of the optical element 10A in the xy coordinates with the first bent portion CP11 and the second bent portion CP22 as the origin.

In the fourth liquid crystal cell 100-4 of the optical element 10A, the first straight line portion LP11 extends at an angle of (90−α) degrees with respect to the x-axis direction. The second straight line portion LP12 extends at an angle of (90−β) degrees with respect to the x-axis direction. The third straight line portion LP23 extends at an angle of −α degrees with respect to the x-axis direction. The fourth straight line portion LP24 extends at an angle of −β degrees with respect to the x-axis direction. In the fourth liquid crystal cell 100-4 of the optical element 10A, the second straight line portion LP12, the fourth straight line portion LP24, the first straight line portion LP11, and the third straight line portion LP23 belong to the first quadrant, the second quadrant, the third quadrant, and the fourth quadrant, respectively. That is, the first straight line portion LP11,the second straight line portion LP12, the third straight line portion LP23, and the fourth straight line portion LP24 belong to different quadrants, also in a plan view of the fourth liquid crystal cell 100-4 of the optical element 10A.

Table 5 shows the straight line portions belonging to each quadrant in the first liquid crystal cell 100-1, the second liquid crystal cell 100-2, the third liquid crystal cell 100-3, and the fourth liquid crystal cell 100-4. Table 6 shows the angles formed with the x-axis direction by the straight line portions belonging to each quadrant in the first liquid crystal cell 100-1, the second liquid crystal cell 100-2, the third liquid crystal cell 100-3, and the fourth liquid crystal cell 100-4.

TABLE 5

| | First | Second | Third | Fourth |
|---|---|---|---|---|
| | Quadrant | Quadrant | Quadrant | Quadrant |
| Fourth Liquid | second | fourth | first | third |
| Crystal Cell | straight | straight | straight | straight |
| 100-4 | portion | portion | portion | portion |
| | LP12 | LP24 | LP11 | LP23 |
| Third Liquid | first | third | second | fourth |
| Crystal Cell | straight | straight | straight | straight |
| 100-3 | portion | portion | portion | portion |
| | LP11 | LP23 | LP12 | LP24 |
| Second Liquid | first | fourth | second | third |
| Crystal Cell | straight | straight | straight | straight |
| 100-2 | portion | portion | portion | portion |
| | LP11 | LP24 | LP12 | LP23 |
| First Liquid | second | third | first | fourth |
| Crystal Cell | straight | straight | straight | straight |
| 100-1 | portion | portion | portion | portion |
| | LP12 | LP23 | LP11 | LP24 |

TABLE 6

| | First | Second | Third | Fourth |
|---|---|---|---|---|
| | Quadrant | Quadrant | Quadrant | Quadrant |
| Fourth Liquid | (90 − β) degrees | −β degrees | (90 − α) degrees | −α degrees |
| Crystal Cell | | | | |
| 100-4 | | | | |
| Third Liquid | (90 − α) degrees | −α degrees | (90 − β) degrees | −β degrees |
| Crystal Cell | | | | |
| 100-3 | | | | |
| Second Liquid | α degrees | (90 + β) degrees | β degrees | (90 + α) degrees |
| Crystal Cell | | | | |
| 100-2 | | | | |
| First Liquid | β degrees | (90 + α) degrees | α degrees | (90 + β) degrees |
| Crystal Cell | | | | |
| 100-1 | | | | |

As can be seen from Tables 5 and 6, even when the first liquid crystal cell 100-1, the second liquid crystal cell 100-2, the third liquid crystal cell 100-3, and the fourth liquid crystal cell 100-4 are stacked in the optical element 10A, similar to optical element 10, the straight line portions belong to each quadrant, and the straight line portions in each quadrant overlap each other at a shifted angle.

As described above, when the arrangement directions of the plurality of liquid crystal cells 100 having the same configuration included in the optical element 10 of the optical device 1 are changed, moire can be reduced. Further, since it is also possible to manufacture the optical element 10A different from the optical element 10 in the liquid crystal cell 100, the liquid crystal cell 100 is highly versatile and the manufacturing cost of the optical device 1 can be reduced.

### Second Embodiment

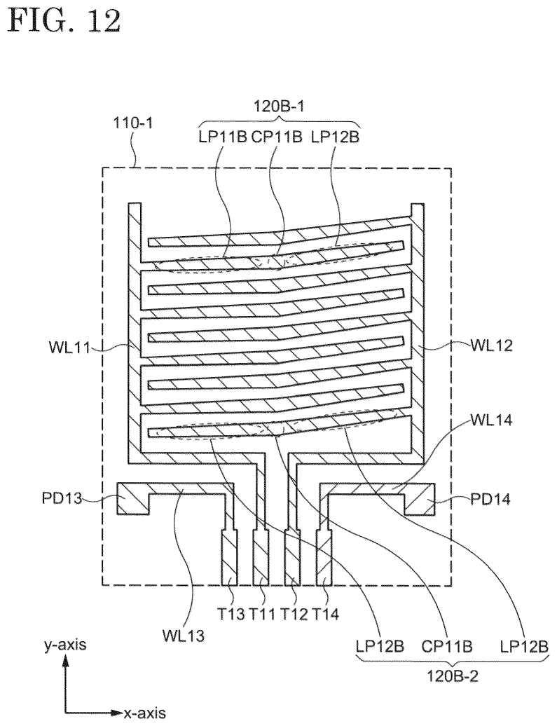

An optical device according to an embodiment of the present invention is described with reference to FIG. 12. In addition, the description of the same configuration as that of the optical device 1 may be omitted in the following description.

FIG. 12 is a schematic plan view showing a planar pattern including a first transparent electrode 120B-1 and a second transparent electrode 120B-2 of a first liquid crystal cell of an optical device according to an embodiment of the present invention.

As shown in FIG. 12, each of the first transparent electrode 120B-1 and the second transparent electrode 120B-2 includes a first straight line portion LP11B, a second straight line portion LP12B, and a first bent portion CP11B. The first straight line portion LP11B and the second straight line portion LP12B intersect and are connected at the first bent portion CP11B. The width of each of the first straight line portion LP11B and the second straight line portion LP12B is not uniform, and increases toward the first bent portion CP11B. In addition, although the width of each of the first straight line portion LP11B and the second straight line portion LP12B gradually increases toward the first bent portion CP11B in FIG. 12, the width may increase in a step manner.

In the optical device according to the present embodiment, since the width of transparent electrode 120B and the inter-electrode pitch between the adjacent first transparent electrode 120B-1 and second transparent electrode 120B-2 are changed, moire can be further reduced.

### Third Embodiment

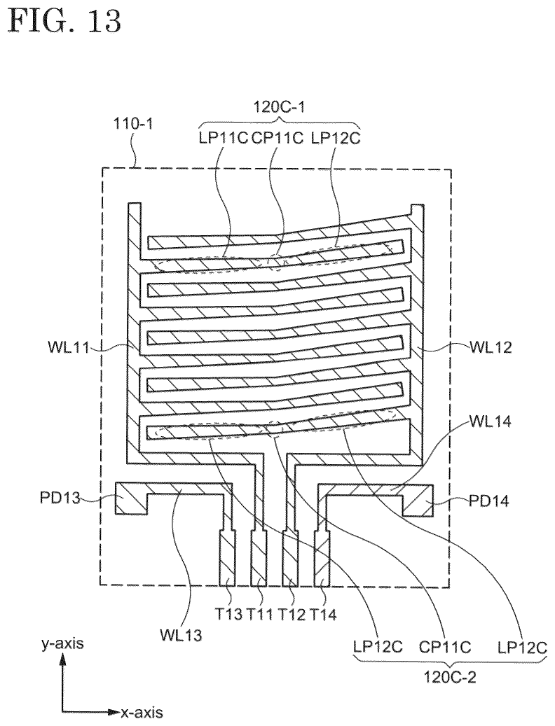

An optical device according to an embodiment of the present invention is described with reference to FIG. 13. In addition, the description of the same configuration as that of the optical device 1 may be omitted in the following description.

FIG. 13 is a schematic plan view showing a planar pattern including a first transparent electrode 120C-1 and a second transparent electrode 120C-2 of a first liquid crystal cell of an optical device according to an embodiment of the present invention.

As shown in FIG. 13, each of the first transparent electrode 120C-1 and the second transparent electrode 120C-2 includes a first straight line portion LP11C, a second straight line portion LP12C, and a first bent portion CP11C. The first straight line portion LP11C and the second straight line portion LP12C intersect and are connected at the first bent portion CP11C. The width of each of the first straight line portion LP11C and the second straight line portion LP12C is not uniform, and decreases toward the first bent portion CP11C. In addition, although the width of each of the first straight line portion LP11B and the second straight line portion LP12B gradually decreases toward the first bent portion CP11C in FIG. 13, the width may become smaller in a step manner.

In the optical device according to this embodiment, since the width of the transparent electrode 120C and the inter-electrode pitch between the adjacent first transparent electrode 120C-1 and second transparent electrode 120C-2 are changed, moire can be further reduced.

### Fourth Embodiment

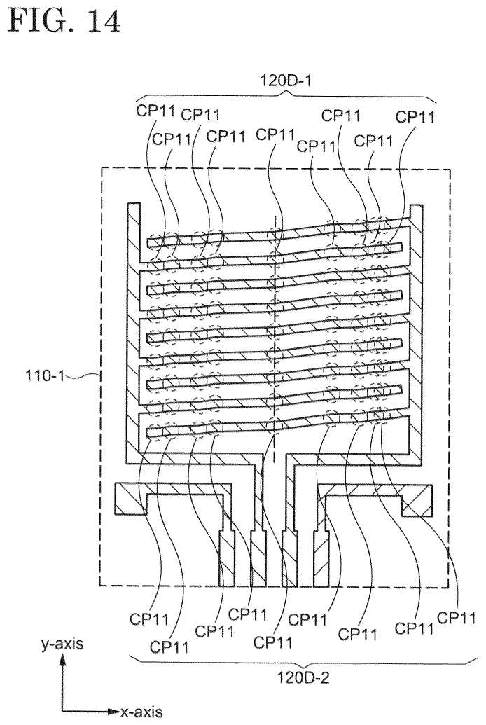

An optical device according to an embodiment of the present invention is described with reference to FIG. 14. In addition, the description of the same configuration as that of the optical device 1 may be omitted in the following description.

FIG. 14 is a schematic plan view showing a planar pattern including a first transparent electrode 120D-1 and a second transparent electrode 120D-2 of a first liquid crystal cell of an optical device according to an embodiment of the present invention.

As shown in FIG. 14, each of the first transparent electrode 120C-1 and the second transparent electrode 120C-2 includes a plurality of first bent portions CP11. The plurality of first bent portions CP11 may be provided regularly or randomly. However, the first bent portions CP11 located in the center are provided regularly so as to be on a straight line extending in the y-axis direction.

In the optical device according to this embodiment, since the overlap of the transparent electrodes 120D of the plurality of liquid crystal cells in the stacking direction is reduced, moire can be further reduced.

Each of the embodiments described above as the embodiments of the present invention can be appropriately combined and implemented as long as no contradiction is caused. Furthermore, the addition, deletion, or design change of components, or the addition, deletion, or condition change of processes as appropriate by those skilled in the art based on each embodiment are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. An optical device, comprising:
a light source; and
an optical element comprising a plurality of liquid crystal cells for controlling a distribution of light emitted from the light source,
wherein:
each of the plurality of liquid crystal cells comprises:
a first substrate on which a first electrode and a second electrode are alternately arranged,
a second substrate on which a third electrode and a fourth electrode are alternately arranged, and
a liquid crystal layer between the first substrate and the second substrate,
each of the first electrode and the second electrode comprises:
a first straight line portion extending at an angle of α degrees (0 <α<90) with respect to a first direction, and
a second straight line portion extending at an angle of β degrees (0<β<90 and β≠α) with respect to the first direction,
each of the third electrode and the fourth electrode comprises:
a third straight line portion extending at an angle of (90+α) degrees with respect to the first direction, and
a fourth straight line portion extending at an angle of (90+β) degrees with respect to the first direction,
the plurality of liquid crystal cells comprises a first liquid crystal cell arranged closest to the light source and a second liquid crystal cell arranged stacked on the first liquid crystal cell,
the first substrate of the second liquid crystal cell faces the second substrate of the first liquid crystal cell, and
the second liquid crystal cell is arranged by overlapping the first liquid crystal cell so that an angle between the first direction of the first liquid crystal cell and the first direction of the second liquid crystal cell is 180 degrees.

2. The optical device according to claim 1, wherein in a plan view, a first bent portion connecting the first straight line portion and the second straight line portion overlaps a second bent portion connecting the third straight line portion and the fourth straight line portion.

3. The optical device according to claim 2,
wherein:
a width of each of the first straight line portion and the second straight line portion increases toward the first bent portion, and
a width of each of the third straight line portion and the fourth straight line portion increases toward the second bent portion.

4. The optical device according to claim 2,
wherein:
a width of each of the first straight line portion and the second straight line portion decreases toward the first bent portion, and
a width of each of the third straight line portion and the fourth straight line portion decreases toward the second bent portion.

5. The optical device according to claim 1,
wherein:
each of the first electrode and the second electrode includes a plurality of first bent portions each connecting the first straight line portion and the second straight line portion,
each of the third electrode and the fourth electrode includes a plurality of second bent portions each connecting the third straight line portion and the fourth straight line portion, and
one of the plurality of first bent portions overlaps one of the plurality of second bent portions.

6. The optical device according to claim 1,
wherein:
the plurality of liquid crystal cells further comprises a third liquid crystal cell stacked on the second liquid crystal cell on an opposite side of the first liquid crystal cell, and a fourth liquid crystal cell stacked on the third liquid crystal cell on an opposite side of the second liquid crystal cell,
the second substrate of the third liquid crystal cell faces the second substrate of the second liquid crystal cell,
the second substrate of the fourth liquid crystal cell faces the first substrate of the third liquid crystal cell,
the third liquid crystal cell is arranged by overlapping the first liquid crystal cell and the second liquid crystal cell so that an angle between the first direction of the first liquid crystal cell and the first direction of the third liquid crystal cell is 180 degrees, and
the fourth liquid crystal cell is arranged by overlapping the first liquid crystal cell and the third liquid crystal cell so that an angle between the first direction of the first liquid crystal cell and the first direction of the fourth liquid crystal cell is 0 degrees.

7. The optical device according to claim 1,
wherein:
the plurality of liquid crystal cells further comprises a third liquid crystal cell arranged on the second liquid crystal cell on an opposite side of the first liquid crystal cell, and a fourth liquid crystal cell arranged on the third liquid crystal cell on an opposite side of the second liquid crystal cell,
the second substrate of the third liquid crystal cell faces the second substrate of the second liquid crystal cell,
the second substrate of the fourth liquid crystal cell faces the first substrate of the third liquid crystal cell,
the third liquid crystal cell is arranged by overlapping the first liquid crystal cell and the second liquid crystal cell so that an angle between the first direction of the first liquid crystal cell and the first direction of the third liquid crystal cell is 90 degrees, and
the fourth liquid crystal cell is arranged by overlapping the first liquid crystal cell to the third liquid crystal cell so that an angle between the first direction of the first liquid crystal cell and the first direction of the fourth liquid crystal cell is 90 degrees.
